(19) United States
(12) Patent Application Publication
(10) Pub. No.: US 2023/0315451 A1
(43) Pub. Date: Oct. 5, 2023

(54) TECHNOLOGY TO SUPPORT BITMAP MANIPULATION OPERATIONS USING A DIRECT MEMORY ACCESS INSTRUCTION SET ARCHITECTURE

(71) Applicant: Intel Corporation, Santa Clara, CA (US)

(72) Inventors: Shruti Sharma, Beaverton, OR (US); Robert Pawlowski, Beaverton, OR (US); Fabio Checconi, Fremont, CA (US); Jesmin Jahan Tithi, San Jose, CA (US)

(21) Appl. No.: 18/326,623

(22) Filed: May 31, 2023

(51) Int. Cl. G06F 9/30; G06F 13/28

(52) U.S. Cl. CPC G06F 9/30043; G06F 9/30079; G06F 13/28

(57) ABSTRACT

Systems, apparatuses and methods may provide for technology that detects, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline. The technology also detects, by the operation engine, one or more arguments in the plurality of sub-instruction requests, sends, by the operation engine, one or more load requests to a DRAM in the plurality of DRAMs in accordance with the one or more arguments, and sends, by the operation engine, one or more store requests to the DRAM in accordance with the one or more arguments, wherein the operation engine is to correspond to the DRAM.

### GOVERNMENT LICENSE RIGHTS

This invention was made with government support under W911NF22C0081-0102 awarded by the Office of the Director of National Intelligence—AGILE. The government has certain rights in the invention.

### TECHNICAL FIELD

Embodiments generally relate to direct memory access (DMA) operations. More particularly, embodiments relate to technology to support bitmap manipulation operations using a direct memory access (DMA) instruction set architecture (ISA).

### BACKGROUND

Recent developments may have been made in the use of bitmaps and a direct memory access (DMA) instruction set architecture (ISA) in artificial intelligence (AI) computations. There remains considerable room for improvement, however, with respect to the bitmaps in terms of efficiency.

### BRIEF DESCRIPTION OF THE DRAWINGS

The various advantages of the embodiments will become apparent to one skilled in the art by reading the following specification and appended claims, and by referencing the following drawings, in which:

FIG. 1A is a slice diagram of an example of a memory system according to an embodiment;

FIG. 1B is a tile diagram of an example of a memory system according to an embodiment;

FIG. 2 is a block diagram of an example of a direct memory access (DMA) bitmap operation flow;

FIG. 3A is a block diagram of an example of a bitmap gather operation according to an embodiment;

FIG. 3B is an illustration of an example of a pseudocode listing to conduct bitmap gather operations according to an embodiment;

FIG. 4A is a block diagram of an example of a bitmap scatter operation according to an embodiment;

FIG. 4B is an illustration of an example of a pseudocode listing to conduct bitmap scatter operations according to an embodiment;

FIG. 5 is an illustration of an example of a pseudocode listing to conduct bitmap population count operations according to an embodiment;

FIG. 6 is an illustration of an example of a pseudocode listing to conduct bitmap find first bit set operations according to an embodiment;

FIG. 7A is a block diagram of an example of a bitmap extract operation according to an embodiment;

FIG. 7B is an illustration of an example of a pseudocode listing to conduct bitmap extract operations according to an embodiment;

FIG. 8 is a flowchart of an example of a method of operating a performance-enhanced memory system according to an embodiment;

FIG. 9 is a block diagram of an example of a performance-enhanced computing system according to an embodiment;

FIG. 10 is an illustration of an example of a semiconductor package apparatus according to an embodiment;

FIG. 11 is a block diagram of an example of a processor according to an embodiment; and

FIG. 12 is a block diagram of an example of a multi-processor based computing system according to an embodiment.

### DETAILED DESCRIPTION

Bitmaps are commonly used in software to represent sets of integers. Bitmap manipulation operations map directly to set operations on the represented integer sets. An integer i belonging to a set S corresponds to the i-th bit in the string of bits S_{REP} representing S. For example, the intersection of two sets S and S′ is represented by the bitwise AND of their representations S_{REP} and S_{REP}′ and their union by the bitwise OR of the representations.

Particularly relevant application of bitmaps as set representations are Bloom filters, where elements of an arbitrary set are hashed to the elements of a bitmap. When testing for the membership of a key to the set, the bitmap is checked first, to limit the more expensive lookups into the full representation of the set (e.g., a hash table) only to the cases that are not filtered out by the Bloom filter.

Bitmaps are also used as masks in certain vectorized instruction sets, to specify to which elements of a vector an instruction applies. In some cases mask (bitmap) manipulation instructions are part of the instruction set. While these masks are of length limited by the width of the vector size, a similar mechanism may be applicable to conditional direct memory access (DMA) operations.

Traditional approaches to manipulating bitmap representations of vectors may be software-focused implementations on cache-based architectures, which can lead to performance inefficiencies that are commonly seen for artificial intelligence (AI) computing graph analytics on larger sparse datasets. Sequential accesses into dense data structures (e.g., index arrays and packed data arrays) do not suffer when operating through the cache. Because of the low spatial and temporal locality, however, of the randomly accessed sparse data, cacheline utilization may suffer significantly, disproportionately affecting overall miss rates and performance. This behavior may become more prominent as dataset sizes further increase and distributed memory architectures are used to grow the overall memory capacity of the system. The result may be a scenario in which cache misses become even more costly as data is being fetched from a socket at the far end of the system.

The technology described herein provides an ISA and architectural support for direct memory operations that manipulate bitmap representations of graph data structures. Embodiments use near-memory compute capability and provide full hardware support to execute functions such as finding the first set bit in a bitmap, executing a bitmap gather or scatter, and counting the total number of asserted bits in the bitmap. Providing entire bitmap operations as an ISA enables improved software efficiency to be achieved. Additionally, the implementation is done outside of the core cache hierarchy to provide greater efficiency through improved memory and network bandwidth utilization. Moreover, the use of near-memory compute reduces total latency by eliminating extra network traversals and taking the shortest total path to all physical memory locations involved in the operation.

A memory system (e.g., Transactional Integrated Global-memory system with Dynamic Routing and End-to-end flow control/TIGRE) system as described herein is a 64-bit Distributed Global Address Space (DGAS) system solution for mixed-mode (sparse and dense) analytics at scale. TIGRE implements complex DMA operations specifically designed to address common primitives seen in graph procedures.

Implementing bitmap operations on the TIGRE system involves a subsystem including pipeline-local DMA engines and near-memory compute at all endpoints in the system. Additionally, an atomic lock buffer positioned adjacent to the memory is implemented to facilitate remote atomic lock/unlock operations involved in the DMA bit manipulation operations.

In one example, each TIGRE pipeline offloads DMA operations (e.g., exposed in the ISA) to a local memory engine (MENG), wherein eight of the TIGRE pipelines are co-located with a shared cache and local SRAM scratchpad to create a TIGRE slice. A TIGRE tile may include eight slices (e.g., 64 pipelines) and sixteen local DRAM channels. As the system scales out, multiple tiles comprise a TIGRE socket, and the socket count increases to expand the full system.

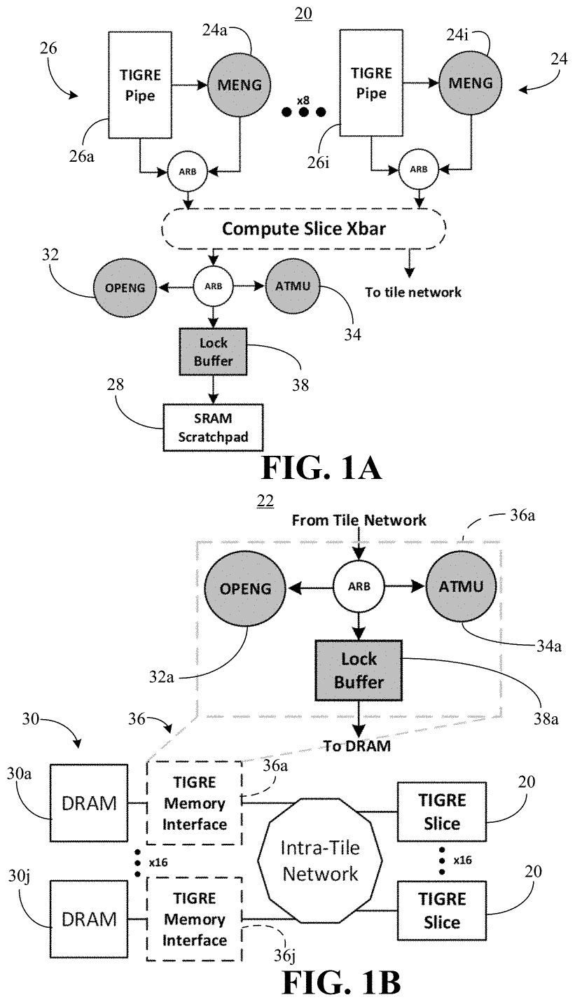

Turning now to FIGs. 1A and 1B, a TIGRE slice 20 diagram and a TIGRE tile 22 diagram are shown, respectively. FIGs. 1A and 1B show the lowest levels of the hierarchy of the TIGRE system. More particularly, the TIGRE slice 20 includes a plurality of memory engines 24 (24a-24i) corresponding to a plurality of pipelines 26 (26a-26i), wherein each memory engine 24 is adjacent to a pipeline in the plurality of pipelines 26. Each TIGRE pipeline 26 offloads DMA operations (e.g., exposed in the ISA) to a local memory engine 24 (MENG). In the illustrated example, eight of the TIGRE pipelines 26 are co-located with a shared cache (not shown) and a local SRAM scratchpad 28 to create the TIGRE slice 20. The illustrated TIGRE tile 22 includes eight slices 20—e.g., sixty-four pipelines 26 and sixteen local DRAM channels 30 (30a-30j). Specifically, the DMA subsystem hardware is made of up units that are local to the pipeline 26 as well as in front of all scratchpad 28 and DRAM channel 30 interfaces.

Atomic units 34 (e.g., 34a-34j, not shown, e.g., ATMUs) are positioned adjacent to scratchpad 28 and memory interfaces 36, and handle the compute and read-lock/write-unlock functionality remote atomic operations. Requests can be sent to the ATMUs 34 directly by the pipelines 26 or by the memory engines 24. The ATMUs 34 include an integer and floating-point computation unit, as well as a local load-store buffer to support parallel execution of instructions while also maintaining high throughput atomic read-write requests to the DRAM channels 30.

The memory engines 24 (MENGs) receive DMA bitmap requests from the local pipelines 26 and initiate the operation. For example, a first MENG 24a is responsible for requesting one or more DMA bitmap manipulation operations associated with a first pipeline 26a. Thus, the first MENG 24a sends out remote load-stores, direct or indirect, with or without an atomic operation. The first MENG 24a also tracks the remote load stores sent and waits for all the responses to return before sending a final response back to the first pipeline 26a.

Operation engines 32 (32a-32j, not shown, e.g., OPENGs) are positioned adjacent to memory interfaces 36 (36a-36j) and receive the load-store requests from the MENGs 24. The OPENGs 32 are responsible for performing the actual memory load-store, converting stored pointer values to physical addresses, and sending a follow-on load/store or atomic request if appropriate. Details pertaining to the role of the OPENGs 32 in the DMA bitmap manipulation operations are provided below.

Lock buffers 38 are positioned in front of the memory port and maintain line-lock statuses for memory addresses. Each lock buffer 38 is a multi-entry buffer that allows for multiple locked addresses in parallel per memory interface 36, supports 64 byte (B) or 8B requests, handles partial line updates and write-combining for partial stores, and supports “read-lock” and “write-unlock” requests within atomic operations (“atomics”). The lock buffers 38 double as a small cache to allow fast access to memory data for bitmap manipulation operations.

Memory System Remote Bitmap Manipulation Operations

In the memory system described herein, bitmap manipulation operations may be performed using the DMA bitmap instructions listed in Table I. In general, the DMA bitmap instructions are passed with arguments (e.g., function parameters and/or modifiers) that inform the recipient of the DMA bitmap instructions as to how to handle/process the instructions. More particularly, DMA bitmap instructions are issued from the pipeline to its corresponding local MENG 24, which then utilizes the OPENG 32 and ATMU 34 near the source and destination memory locations. In addition to direct bitmap manipulation, these instructions enable batched bitmap manipulation (e.g., bitmap operations performed on a series of bitmaps pointed to by an initial list).

TABLE I

| Instruction | Assembly Code for Arguments |
|---|---|
| Dma.bgather | R1, r2, r3, r4, r5, DMA_type, SIZE |
| (DMA bitmap gather) | R1 = Dest bitmap Address |
| | R2 = Index_array |
| | R3 = Count |
| | R4 = Src_bitmap Address |
| | R5 = Result Address |
| | DMA_type = opcode, optype information |
| Dma.bscatter | R1, r2, r3, r4, r5, DMA_type, SIZE |
| (DMA bitmap Scatter) | R1 = Dest bitmap Address |
| | R2 = Index_array |
| | R3 = Count |
| | R4 = Src_bitmap Address |
| | R5 = Result Address |
| | DMA_type = opcode, optype information |
| Dma.bcount | R1, r2, r3, DMA_type, SIZE |
| (DMA bitmap population | R1 = dest address |
| count) | R2 = src address |
| | R3 = count |
| | DMA_type = opcode, optype information |
| Dma.bff | R1, r2, r3, DMA_type, SIZE |
| (DMA bitmap find first | R1 = register for storing the first index value |
| bit set) | R2 = src address |
| | R3 = count |
| | DMA_type = opcode, optype information |
| Dma.bextract | R1, r2, r3, r4, DMA_type, SIZE |
| (DMA bitmap extract) | R1 = index_Array |
| | R2 = Result_Address |
| | R3 = src address |
| | R4 = count |
| | DMA_type = opcode, optype information |

Table I demonstrates that DMA operations receive the DMA_Type field as part of an ISA instruction. The DMA_type field contains information on mode of addressing, data type representation and destination atomic operation (if specified). Table II describes the functionality of different bit fields in the DMA Type modifier.

TABLE II

| DMA_Type | | |
|---|---|---|
| Bits | Function | |
| [0] | 0 = Base offset Mode, 1 = Address Mode; | DMA.convert: [1: 0] = |
| | DMA.reduce: 1 = Direct Array reduce; | Destination Data Type; |
| | Dma.copystride: 0 = passthrough, 1 = | 00 = int, 01 = unsigned, |
| | pack/unpack; | 10 = float, 11 = raw bits |
| [1] | Dma.copystride(pack/unpack): 0 = pack, | |
| | 1 = unpack | |
| | dma.gather: 1 = atomic_increment_src | |
| [2] | offset pointer size | DMA.convert: [1: 0] = |
| [3] | offset pointer type | Destination Size; 00 = |
| | | 1 Byte, 01 = 2 Byte, |
| | | 10 = 3 Byte, 11 = 4 Byte |

| | |
|---|---|
| [4] | Complement src |
| [5] | Complement destination |
| [7: 6] | operand type: 00 = int, 01 = unsigned, 10 = float, 11 = raw bits |
| [10: 8] | atomic_opcode |

Table III further explains the atomic operations used for DMA instructions. The bit fields in the DMA_Type argument accommodate operations in a relatively low number of bits and provide flexibility for future added functionality.

TABLE III

| DMA_type[7: 6] | DMA_type[10: 8] |
|---|---|
| (data_type) | (atomic_opcode) |
| 00(int) | 000 = overwrite |
| | 001 = compare overwrite |
| | 010 = Add |
| | 011 = Mul |
| | 100 = Max |
| | 101 = Min |
| | 110 = Reserved |
| | 111 = Reserved |
| 01(Unsigned) | 000 = overwrite |
| | 001 = compare overwrite |
| | 010 = Add |
| | 011 = Mul |
| | 100 = Max |
| | 101 = Min |
| | 110 = Reserved |
| | 111 = Reserved |
| 10(float) | 000 = overwrite |
| | 001 = compare overwrite |
| | 010 = Add |
| | 011 = Mul |
| | 100 = Max |
| | 101 = Min |
| | 110 = Reserved |
| | 111 = Reserved |
| 11(Raw bits) | 000 = NONE(Overwrite) |
| | 001 = bit_atomic_AND(for bitmap instructions), |
| | BITWISE AND for other instructions |
| | 010 = bit_atomic_OR(for bitmap instructions), |
| | BITWISE OR for other instructions |
| | 011 = bit_atomic_XOR(for bitmap instructions), |
| | BITWISE XOR for other instructions |
| | 011 = bit_atomic_TEST_AND_SET(for bitmap |
| | instructions), Reserved for other instructions |
| | 101 = Reserved |
| | 110 = Reserved |
| | 111 = Reserved |

Bitmap Manipulation using DMA

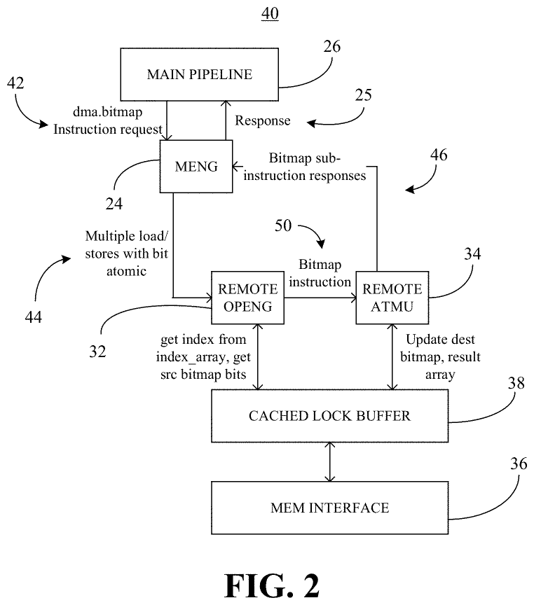

FIG. 2 shows an operation flow 40 of the DMA bitmap manipulation operations through the architecture. A description of the responsibilities of each unit in executing the operation is as follows.

The MENG 24 receives a DMA bitmap manipulation instruction 42 from the local pipeline 26. The MENG 24 stores the instruction information into a local buffer slot and sends out “count” number of sub-instruction requests 44 (e.g., one sub-instruction request per data element) to each remote OPENG 32. The type of sub-instruction sent to the OPENG 32 is dependent on the type of bitmap manipulation instruction 42 being executed. After sending “count” number of sub-instruction requests 44 out to the OPENG 32, the MENG 24 waits for “count” number of responses 46. Once the MENG 24 receives all the responses 46 back, the MENG 24 sends a final response 25 back to the pipeline 26 and the instruction 42 is considered complete.

The OPENG 32 receives multiple requests from the MENG 24 describing the operation to be performed. The OPENG 32 is the unit responsible for sending the actual load/store requests to the memory interface 36. For instructions requiring indirect load/store operations, the OPENG 32 is responsible for performing the operation by loading the pointer value from the memory, computing the next destination address, and creating the follow-on load/store request. For instructions involving atomic operations at the destination, the OPENG 32 sends bitmap instructions 50 (e.g., requests) to the remote ATMU 34 with source and destination address information, data value and opcode type.

The ATMU 34 receives the atomic bitmap (e.g., “bit-atomic”) instructions 50 from the OPENG 32 and performs the atomic operation to update the destination bitmap and result array. The ATMU 34 performs the atomic operation by sending the read-lock and write-unlock instructions to the memory interface 36. All accesses by the ATMU 34 to memory are handled by the cached locked buffer 38 positioned next to the memory interface 36. The lock buffer 38 locks an address when a locked-read request is received from the ATMU 34. The address is locked until the ATMU 34 sends a write-unlock request for the same address. Once the ATMU 34 completes the operation, the ATMU 34 sends a response 46 (e.g., packet) back to the MENG 24. Table IV provides additional descriptions of the fields used in the DMA bitmap operations.

TABLE IV

| | |
|---|---|
| Destination | Base address of the memory location to store the |
| Bitmap Address; | destination bitmap. The bitmap is stored in |
| | contiguous 8 Byte memory locations. To access i'th |
| | bit in destination bitmap, we need to load 8 Byte |
| | word from {(i/64)*8}'th location |
| Index Array; | Index array contains index values of “SIZE” stored |
| | in contiguous memory locations. |
| | dma.bgather: gives the indices of src bitmap to |
| | gather the bits from |
| | dma.bscatter: gives the indices of dest bitmap to |
| | scatter the bits to |
| | dma.bextract: store the indices of source bitmap |
| Count; | dma.bscatter, dma.bgather: Number of index |
| | values stored in index array |
| | dma.bextract, dma.bff, dma.bcount: Number of |
| | bits in source bitmap |
| Src Bitmap Address; | Source bitmap is stored in contiguous 8 Byte |
| | memory locations. To access I'th bit in source |
| | bitmap, we need to load 8 Byte word from |
| | {(i/64)*8}'th location |
| Result Address; | Dma.bscatter, dma.bgather: Result bitmap has |
| | number of bits equal to destination bitmap. We |
| | modify or not modify the result bitmap based on the |
| | opcode. Result bitmap is stored in contiguous 8 |
| | Byte memory locations. To access i'th bit in result |
| | bitmap, we need to load 8 Byte word from |
| | {(I'64)*8}'th location. |
| | Dma.bcount: scalor population count value |
| | Dma.extract: Number of indices stored in index |
| | array |

DMA Bitmap Gather Operations

dma.bgather r1, r2, r3, r4, r5, DMA_type, SIZE

R1=Dest bitmap Address; R2=Index_array; R3=Count; R4=Src_bitmap Address; R5=Result Address

The dma.bgather instruction copies bits from various indices of a source bitmap and stores the copied bits in a contiguous destination bitmap. The base address of the array of the indices (e.g., containing a list of offsets) to load from the source bitmap is given by the “index_array” input value (e.g., argument).

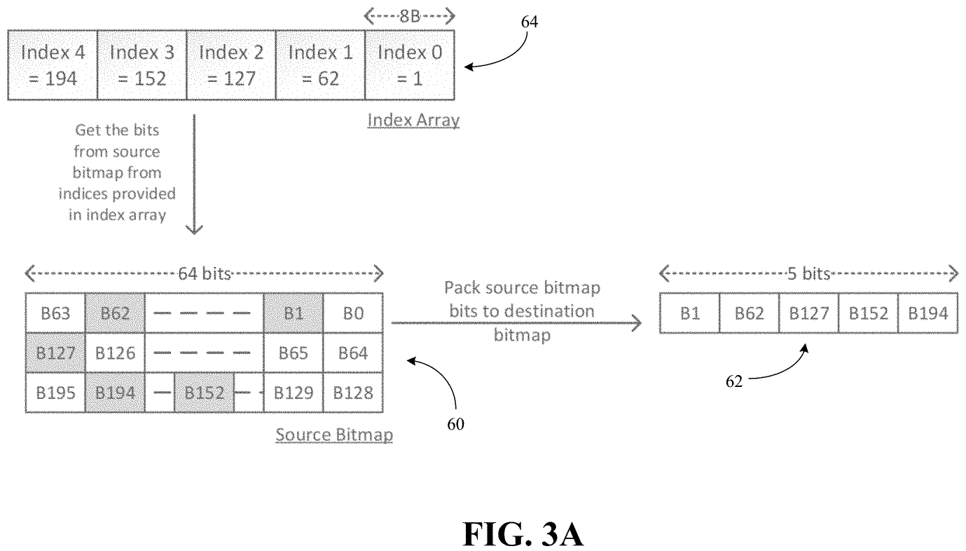

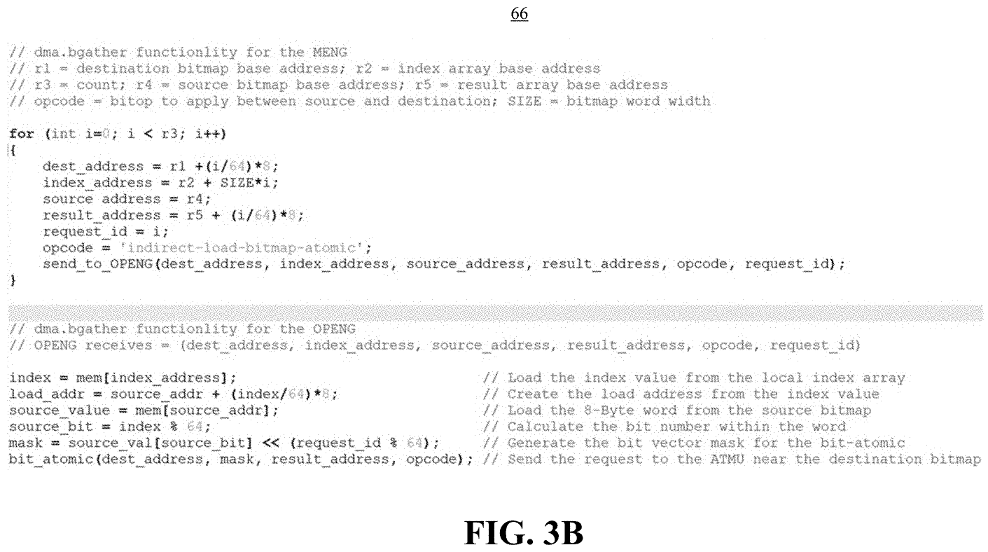

FIG. 3A shows an example of the dma.bgather operation in which five unique indices (“count”=5) are moved from a source bitmap 60 into a destination bitmap 62. Each index in an index array 64 points to a specific bit in the source bitmap 60 array that is copied to the packed destination bitmap 62. Because the bit-atomic opcode specified by the DMA_Type input in this example is “NONE”, the source bits are directly copied to the destination bitmap 62 with no additional operation performed. For other bit-atomic opcodes, the corresponding operation is performed between the source bit-value and pre-existing bit-value in the respective location of the destination bitmap 62, with the result being stored back to destination bitmap 62. The “result address” input (r5) is not shown in the example diagram and will be the location where the old value (e.g., preceding the atomic operation at the destination array) will be returned to allow the programmer to verify the result of the bitmap gather operation.

FIG. 3B shows a pseudocode listing 66 describing the functionality of both the MENG and OPENG when executing the dma.bgather instruction. The MENG send “count” (r3) number of total requests to the OPENG, with each request handling a unique corresponding bit position within all arrays. Each request has a unique destination array, index array, and result array addresses. For each request received, the OPENG loads the index value to compute the exact load address, fetches the source value, determines the bitmask, and executes an atomic write to the destination bitmap. The physical locations of the arrays in the system may vary (e.g., the sequence of operations shown for the OPENG may be executed by multiple physical OPENG units, with each being local to a corresponding data structure).

DMA Bitmap Scatter Operations

dma.bscatter r1, r2, r3, r4, r5, DMA_type, SIZE

R1=Dest bitmap Address; R2=Index_array; R3=Count; R4=Src_bitmap Address; R5=Result Address

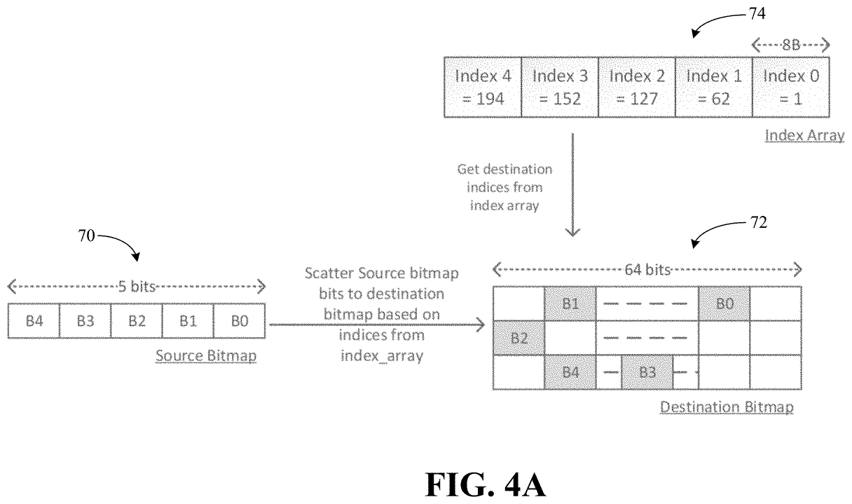

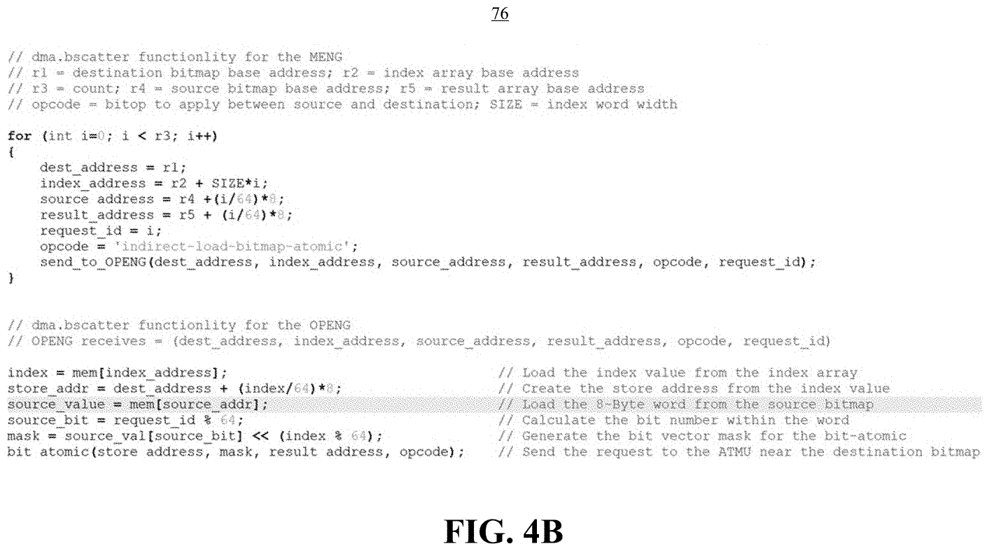

FIG. 4A demonstrates that the dma.bscatter instruction copies the bits from a contiguous (e.g., packed) source bitmap 70 (e.g., of size “count”) and stores the bits to “count” number of different indices in a larger (sparse) destination bitmap 72. The base address of the array of the indices (e.g., containing a list of offsets) to load from the source bitmap 70 are given by an index array 74 input value.

The source bits are directly copied to destination bitmap indices if the bit-atomic opcode provided as part of DMA_Type is “NONE”. For other bit-atomic opcodes, the corresponding operation is performed between the source bit-value and pre-existing bit-value in the respective location of the destination bitmap 72, with the result being stored back to the destination bitmap 72. Along with the destination bitmap 72, result bitmap indices may be modified based on the bit-atomic opcode given as part of DMAType.

FIG. 4B shows an example of a pseudocode listing 76 describing the functionality of both the MENG and OPENG when executing the dma.bscatter instruction. The MENG sends “count” (r3) number of total requests to the OPENG, with each request handling a unique corresponding bit position within all arrays. Each request has unique source array, index array, and result array addresses. For each request received, the OPENG fetches the source value from the source bitmap, loads the index value to compute the exact destination store address, determines the bitmask, and executes an atomic write to the destination bitmap. Again, the physical locations of the arrays in the system may vary (e.g., the sequence of operations shown for the OPENG may be executed by multiple physical OPENG units, with each being local to a corresponding data structure).

DMA Bitmap Population Count Requests/Operations

dma.bcount r1, r2, r3, DMA_type, SIZE

R1=Result Address; R2=Source Bitmap Address; R3=Count;

The dma.bcount instruction counts the total number of 1's in the source bitmap (e.g., base address in the r4 operand). The resulting value for the total number of 1's in the source bitmap is stored in the address pointed to by the r1 input operand. The number of bits to inspect in the source bitmap is given by the count value (r3).

The MENG sends multiple 64B or 8B load requests (e.g., based on the count value) to the near-memory OPENG. The OPENG scans each bit in each loaded word and accumulates the number of 1's in each word (e.g., locally) before sending an atomic add request to ATMU near the result address location to update the result counter.

After all of the atomic add requests are executed by the near-memory ATMU, the result address contains the final count value. The ATMU sends a response back to the source MENG for each of the requests received from OPENG. When the MENG receives all expected responses back, a single final response is sent to the pipeline to retire the instruction.

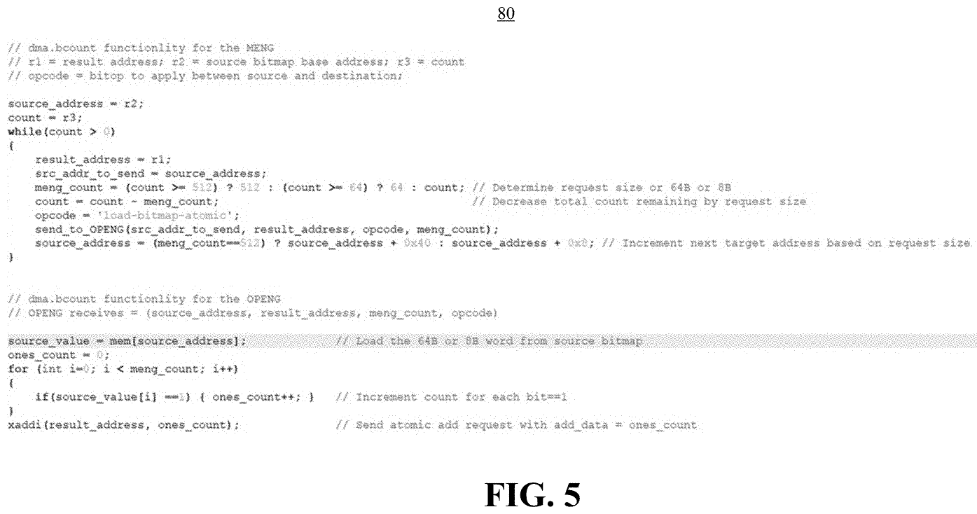

FIG. 5 shows a pseudocode listing 80 describing the functionality of both the MENG and OPENG when executing the dma.bcount instruction. The MENG optimizes the total number of packets sent to the OPENG by sending 64B requests when possible. Each request points to a unique source address within the bitmap. For each request received, the OPENG fetches the source value from the source bitmap and scans for the count, sending an atomic add to the memory location where the total count is accumulated. For dma.bcount, only a single data structure is operated on. Therefore, there is only one OPENG involved for executing each request from the MENG and the packet does not move around the system to multiple memory locations.

DMA Bitmap Find First Bit Set Requests/Operations

dma.bff r1, r2, r3, DMA_type, SIZE

R1=destination register for storing the first index; R2=Source Bitmap Address; R3=Count;

The dma.bff instruction scans the source bitmap starting from 0^{th} bit to find the position of the first bit that is set to one. The total number of bits in the source bitmap is given by the “count” value. The index of first bit set is stored in register R1.

The MENG sends multiple load requests (e.g., based on the count value) to the OPENG. The OPENG inspects each bit in the loaded word starting from bit zero, and finds the first bit set to one in the loaded word. The response returned to the MENG from the OPENG for each request includes the index value of the first asserted bit.

The MENG waits for all expected responses to return from the OPENG. When the first response arrives, the MENG stores the index value received locally. For each subsequent response returning from the OPENG, the MENG compares the stored (e.g., lowest) index with the new index. If the new index is lower than the previous index, the index value is replaced. When all responses are received by the MENG, the MENG sends the final index value to the pipeline as part of the dma.bff instruction retirement.

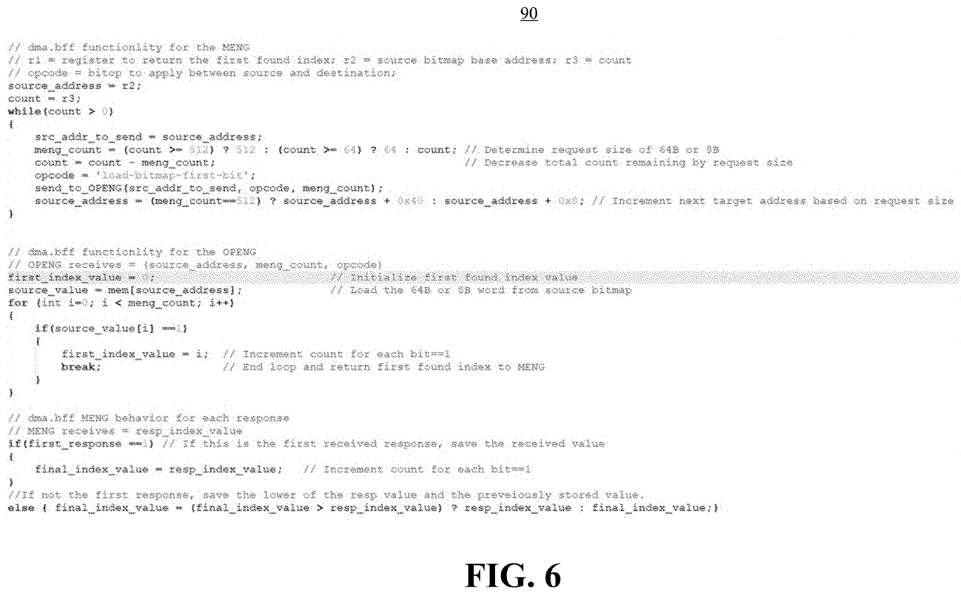

FIG. 6 shows a pseudocode listing 90 describing the functionality of both the MENG and OPENG when executing the dma.bff instruction. The MENG optimizes the total number of packets sent to the OPENG by sending 64B requests when possible. Each request points to a unique source address within the bitmap. For each request received, the OPENG fetches the source value from the source bitmap and scans for the first set bit, sending the location back to the MENG back when found. This operation occurs for each request and therefore the MENG is responsible for tracking the lowest ordered index of the first set bit. For dma.bff, only a single data structure is operated on. Therefore, there is only one OPENG involved for executing each request from the MENG, and the packet does not move around the system to multiple memory locations.

DMA Bitmap Extract Requests/Operations

dma.bextract r1, r2, r3, r4, DMA_type, SIZE

R1=Index_Array; R2=Result_address; R3=Source Bitmap Address; R4=Count;

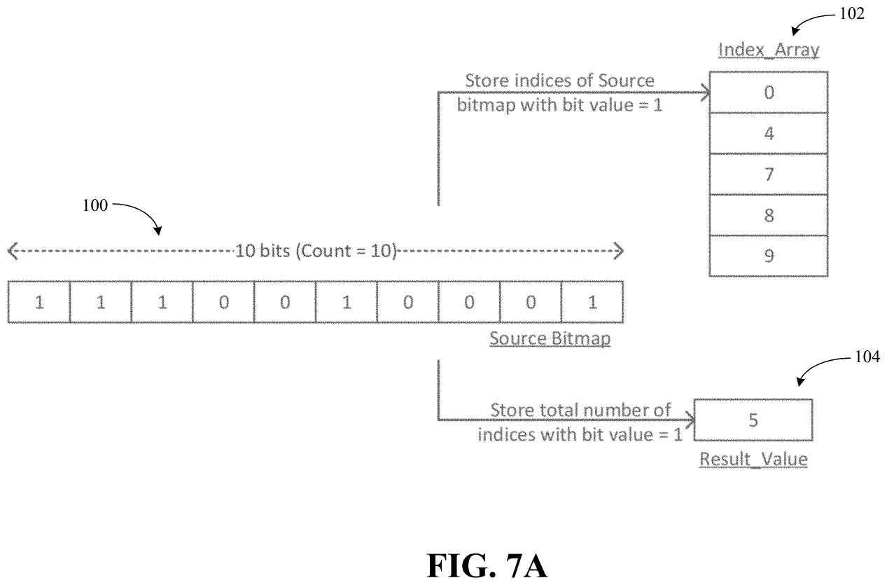

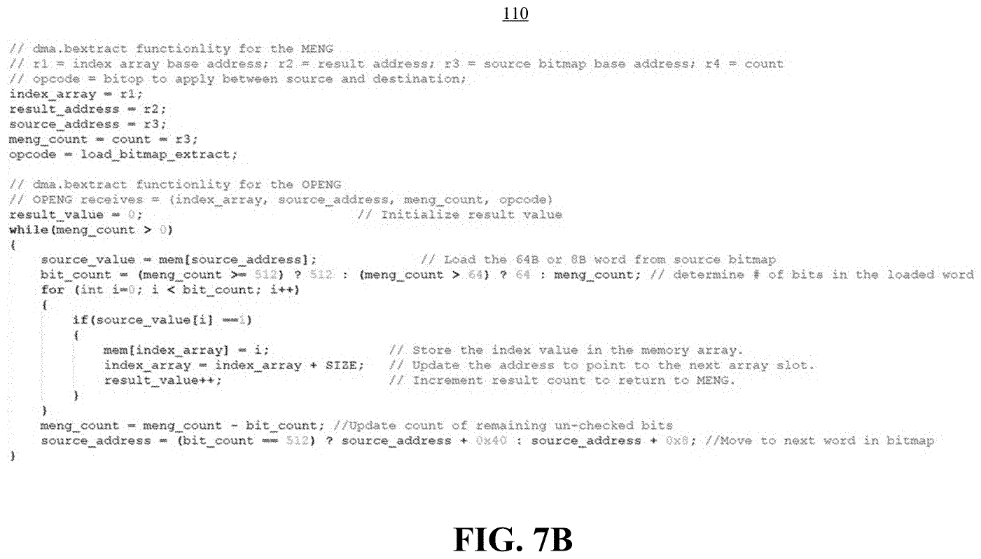

FIG. 7A demonstrates that the dma.bextract instruction scans a source bitmap 100 starting from the 0^{th} bit to the most significant bit (MSB). The indices of all the source bitmap 100 bits equal to one are stored in a contiguous memory location 102 (e.g., index array) starting from the “index_array” address (r1). The count (r4) of all the indices stored is placed in a result address 104 (e.g., result_address (r2)).

For the dma.bextract instruction, the MENG sends a single instruction to the OPENG. The OPENG does “count” number of memory loads from the source bitmap 100 and scans through loaded words to count the total number of bits equal to one. The OPENG then stores the index value for each asserted bit in the contiguous memory location 102. Once the OPENG completes scanning the entire source bitmap and storing the indices, the OPENG sends a single response value to MENG. The MENG receives the response for the bitmap extract instruction and indicates completion of the instruction with the final value of asserted bits.

FIG. 7B shows a pseudocode listing 110 describing the functionality of both the MENG and OPENG when executing the dma.bextract instruction. Unlike the other instructions, the MENG sends only a single request to the remote OPENG for the dma.bextract instruction. For each entry of the source bitmap, the OPENG checks the value and writes the index to the result index array (e.g., may be a remote store) while also incrementing the result value locally. Once the OPENG has scanned through the full source bitmap, the OPENG writes the final result count value to memory using an atomic add operation.

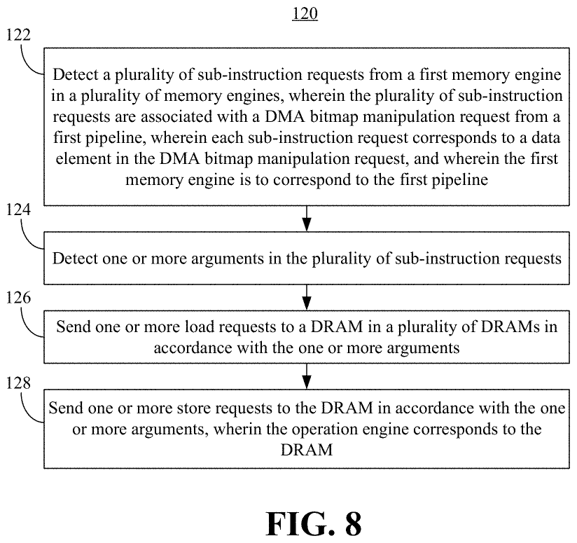

FIG. 8 shows a method 120 of operating a performance-enhanced memory system. The method 120 may generally be implemented in an operation engine such as, for example, the operation engine 32 (FIG. 1A), already discussed. More particularly, the method 120 may be implemented in one or more modules as a set of logic instructions stored in a machine-or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 120 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 122 detects a plurality of sub-instruction requests from a first memory engine in a plurality of memory engines, wherein the plurality of sub-instruction requests are associated with a DMA bitmap manipulation request from a first pipeline. In the illustrated example, each sub-instruction request corresponds to a data element in the DMA bitmap manipulation request and the first memory engine corresponds to the first pipeline. The DMA bitmap manipulation request may be a request to count a number of ones in a source bitmap (e.g., bitmap population count request), a request to locate a first bit that is set to one in a source bitmap (e.g., bitmap find first bit set request), a request to store indices of bits equal to one or a source bitmap to a contiguous memory location (e.g., bitmap extract request), and so forth. The DMA bitmap manipulation request may also be a bitmap gather request and/or a bitmap scatter request.

Block 124 detects one or more arguments in the plurality of sub-instruction requests. In one example, the one or more arguments include one or more of a DMA type argument, an index array argument, a result address argument, or a destination bitmap address argument (see, e.g., Tables I-IV). Block 126 sends one or more load requests to a DRAM in a plurality of DRAMs in accordance with the one or more arguments and block 128 sends one or more store requests to the DRAM in accordance with the one or more arguments, wherein the operation engine corresponds to the DRAM. The method 120 therefore enhances performance at least to the extent that supporting the DMA bitmap manipulation request in the operation engine hardware improves efficiency, memory utilization and/or bandwidth utilization. Additionally, positioning the operation engine near the DRAM (e.g., using near memory compute) reduces total latency by eliminating extra network traversals and taking the shortest total path to all physical memory locations involved in the operation.

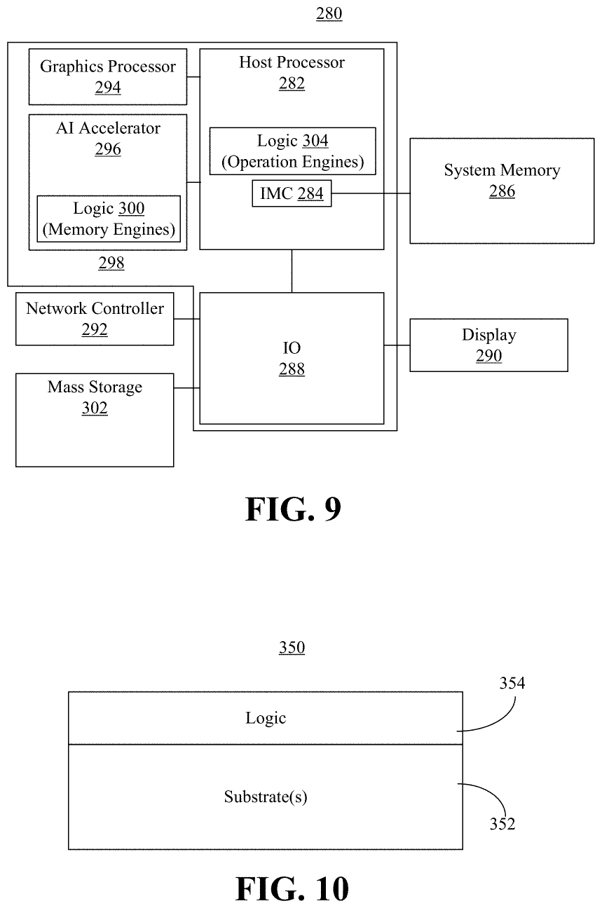

Turning now to FIG. 9, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 (e.g., specialized processor) into a system on chip (SoC) 298.

In an embodiment, the AI accelerator 296 includes memory engine logic 300 and the host processor 282 includes operation engine logic 304, wherein the logic 300, 304 represents a performance-enhanced memory system. The operation engine logic 304 performs one or more aspects of the method 120 (FIG. 8), already discussed. Thus, an operation engine in the operation engine logic 304 (e.g., including a plurality of operation engines) detects a plurality of sub-instruction requests from a first memory engine in the memory engine logic 300 (e.g., including a plurality of memory engines), wherein the plurality of sub-instruction requests are associated with a DMA bitmap manipulation request from a first pipeline. Each sub-instruction request corresponds to a data element in the DMA bitmap manipulation request and the first memory engine corresponds to the first pipeline. The operation engine also detects one or more arguments in the plurality of sub-instruction requests, sends one or more load requests to a DRAM in the system memory 286 (e.g., including a plurality of DRAMs) in accordance with the one or more arguments, and sends one or more store requests to the DRAM in accordance with the one or more arguments, wherein the operation engine corresponds to the DRAM.

The computing system 280 and/or the memory system are therefore considered performance-enhanced at least to the extent that supporting the DMA bitmap manipulation request in the operation engine hardware improves efficiency, memory utilization and/or bandwidth utilization. Additionally, positioning the operation engine adjacent the DRAM (e.g., using near memory compute) reduces total latency by eliminating extra network traversals and taking the shortest total path to all physical memory locations involved in the operation.

FIG. 10 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 120 (FIG. 8), already discussed, and may be readily substituted for the logic 304 (FIG. 9), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

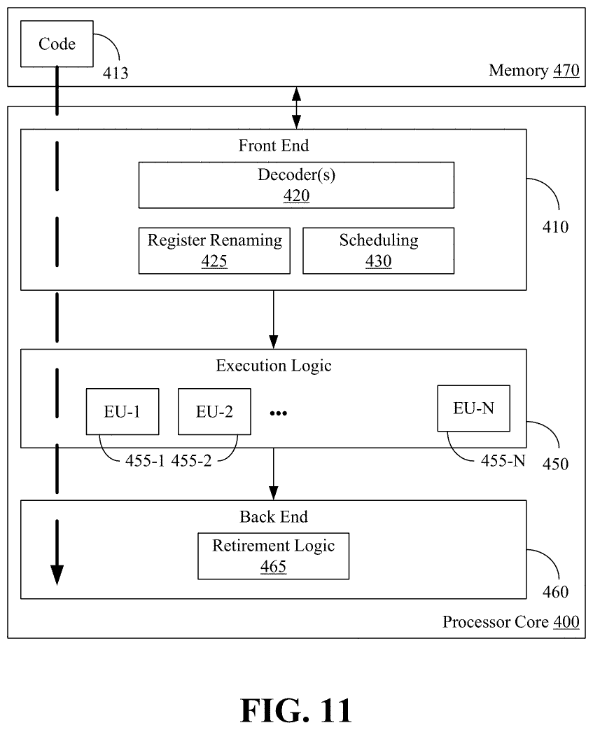

FIG. 11 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 11, a processing element may alternatively include more than one of the processor core 400 illustrated in FIG. 11. The processor core 400 may be a single-threaded core or, for at least one embodiment, the processor core 400 may be multithreaded in that it may include more than one hardware thread context (or “logical processor”) per core.

FIG. 11 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 120 (FIG. 8), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 11, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

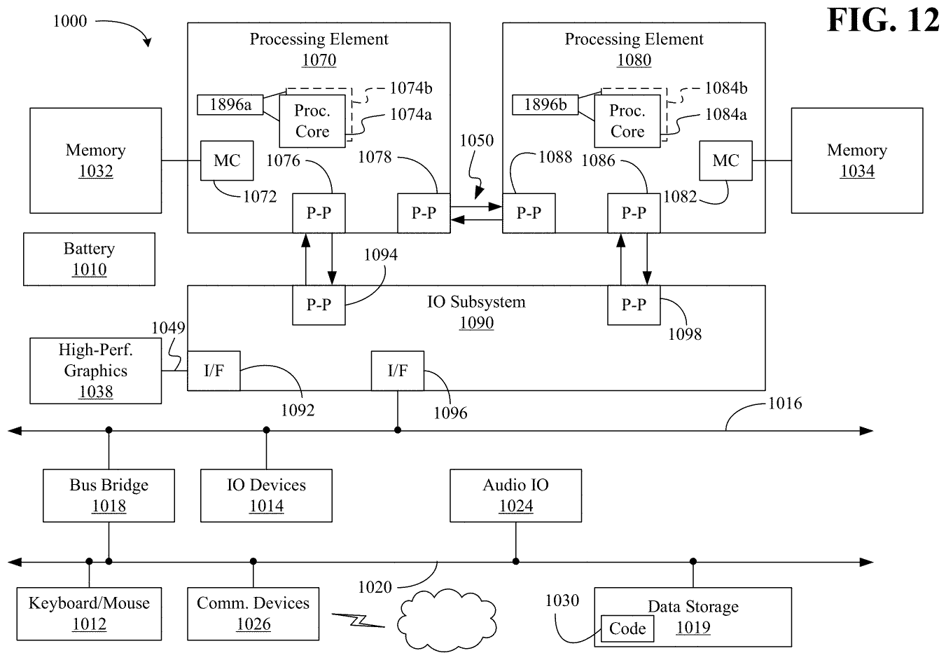

Referring now to FIG. 12, shown is a block diagram of a computing system 1000 embodiment in accordance with an embodiment. Shown in FIG. 12 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 12 may be implemented as a multi-drop bus rather than point-to-point interconnect.

As shown in FIG. 12, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 11.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 12, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 12, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 12, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 120 (FIG. 8), already discussed. Further, an audio I/O 1024 may be coupled to second bus 1020 and a battery 1010 may supply power to the computing system 1000.

Note that other embodiments are contemplated. For example, instead of the point-to-point architecture of FIG. 12, a system may implement a multi-drop bus or another such communication topology. Also, the elements of FIG. 12 may alternatively be partitioned using more or fewer integrated chips than shown in FIG. 12.

### Additional Notes and Examples

Example 1 includes a performance-enhanced computing system comprising a network controller, a plurality of dynamic random access memories (DRAMs), and a processor coupled to the network controller, wherein the processor includes logic coupled to one or more substrates, the logic to detect, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline, detect, by the operation engine, one or more arguments in the plurality of sub-instruction requests, send, by the operation engine, one or more load requests to a DRAM in the plurality of DRAMs in accordance with the one or more arguments, and send, by the operation engine, one or more store requests to the DRAM in accordance with the one or more arguments, wherein the operation engine is to correspond to the DRAM.

Example 2 includes the computing system of Example 1, wherein the one or more arguments include one or more of a DMA type argument, an index array argument, a result address argument or a destination bitmap address argument.

Example 3 includes the computing system of any one of Examples 1 to 2, wherein the DMA bitmap manipulation request is a request to count a number of ones in a source bitmap.

Example 4 includes the computing system of any one of Examples 1 to 2, wherein the DMA bitmap manipulation request is a request to determine a first a first bit that is set to one in a source bitmap.

Example 5 includes the computing system of any one of Examples 1 to 2, wherein the DMA bitmap manipulation request is a request to store indices of bits equal to one in a source bitmap to a contiguous memory location.

Example 6 includes at least one computer readable storage medium comprising a set of executable instructions, which when executed by an operation engine, cause the operation engine to detect a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline, detect one or more arguments in the plurality of sub-instruction requests, send one or more load requests to a dynamic random access memory (DRAM) in a plurality of DRAMs in accordance with the one or more arguments, and send one or more store requests to the DRAM in accordance with the one or more arguments, wherein the operation engine is to correspond to the DRAM.

Example 7 includes the at least one computer readable storage medium of Example 6, wherein the one or more arguments include one or more of a DMA type argument, an index array argument, a result address argument or a destination bitmap address argument.

Example 8 includes the at least one computer readable storage medium of any one of Examples 6 to 7, wherein the DMA bitmap manipulation request is a request to count a number of ones in a source bitmap.

Example 9 includes the at least one computer readable storage medium of any one of Examples 6 to 7, wherein the DMA bitmap manipulation request is a request to determine a first a first bit that is set to one in a source bitmap.

Example 10 includes the at least one computer readable storage medium of any one of Examples 6 to 7, wherein the DMA bitmap manipulation request is a request to store indices of bits equal to one in a source bitmap to a contiguous memory location.

Example 11 includes the at least one computer readable storage medium of any one of Examples 6 to 7, wherein the DMA bitmap manipulation request is a bitmap gather request.

Example 12 includes the at least one computer readable storage medium of any one of Examples 6 to 7, wherein the DMA bitmap manipulation request is a bitmap scatter request.

Example 13 includes a semiconductor apparatus comprising one or more substrates, and logic coupled to the one or more substrates, wherein the logic is implemented at least partly in one or more of configurable or fixed-functionality hardware, the logic to detect, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline, detect, by the operation engine, one or more arguments in the plurality of sub-instruction requests, send, by the operation engine, one or more load requests to a dynamic random access memory (DRAM) in a plurality of DRAMs in accordance with the one or more arguments, and send, by the operation engine, one or more store requests to the DRAM in accordance with the one or more arguments, wherein the operation engine is to correspond to the DRAM.

Example 14 includes the semiconductor apparatus of Example 13, wherein the one or more arguments include one or more of a DMA type argument, an index array argument, a result address argument or a destination bitmap address argument.

Example 15 includes the semiconductor apparatus of any one of Examples 13 to 14, wherein the DMA bitmap manipulation request is a request to count a number of ones in a source bitmap.

Example 16 includes the semiconductor apparatus of any one of Examples 13 to 14, wherein the DMA bitmap manipulation request is a request to determine a first a first bit that is set to one in a source bitmap.

Example 17 includes the semiconductor apparatus of any one of Examples 13 to 14, wherein the DMA bitmap manipulation request is a request to store indices of bits equal to one in a source bitmap to a contiguous memory location.

Example 18 includes the semiconductor apparatus of any one of Examples 13 to 14, wherein the DMA bitmap manipulation request is a bitmap gather request.

Example 19 includes the semiconductor apparatus of any one of Examples 13 to 14, wherein the DMA bitmap manipulation request is a bitmap scatter request.

Example 20 includes the semiconductor apparatus of any one of Examples 13 to 14, wherein the logic coupled to the one or more substrates includes transistor channel regions that are positioned within the one or more substrates.

Example 21 includes a method of operating a performance-enhanced computing system, the method comprising detecting, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline, detecting, by the operation engine, one or more arguments in the plurality of sub-instruction requests, sending, by the operation engine, one or more load requests to a dynamic random access memory (DRAM) in a plurality of DRAMs in accordance with the one or more arguments, and sending, by the operation engine, one or more store requests to the DRAM in accordance with the one or more arguments, wherein the operation engine is to correspond to the DRAM.

Example 22 includes an apparatus comprising means for performing the method of Example 21.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a plurality of dynamic random access memories (DRAMs); and
a processor coupled to the network controller, wherein the processor includes logic coupled to one or more substrates, the logic to:
detect, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline;
detect, by the operation engine, one or more arguments in the plurality of sub-instruction requests;
send, by the operation engine, one or more load requests to a DRAM in the plurality of DRAMs in accordance with the one or more arguments; and
send, by the operation engine, one or more store requests to the DRAM in accordance with the one or more arguments, wherein the operation engine is to correspond to the DRAM.

2. The computing system of claim 1, wherein the one or more arguments include one or more of a DMA type argument, an index array argument, a result address argument or a destination bitmap address argument.

3. The computing system of claim 1, wherein the DMA bitmap manipulation request is a request to count a number of ones in a source bitmap.

4. The computing system of claim 1, wherein the DMA bitmap manipulation request is a request to determine a first a first bit that is set to one in a source bitmap.

5. The computing system of claim 1, wherein the DMA bitmap manipulation request is a request to store indices of bits equal to one in a source bitmap to a contiguous memory location.

6. At least one computer readable storage medium comprising a set of executable instructions, which when executed by an operation engine, cause the operation engine to:
detect a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline;
detect one or more arguments in the plurality of sub-instruction requests;
send one or more load requests to a dynamic random access memory (DRAM) in a plurality of DRAMs in accordance with the one or more arguments; and
send one or more store requests to the DRAM in accordance with the one or more arguments, wherein the operation engine is to correspond to the DRAM.

7. The at least one computer readable storage medium of claim 6, wherein the one or more arguments include one or more of a DMA type argument, an index array argument, a result address argument or a destination bitmap address argument.

8. The at least one computer readable storage medium of claim 6, wherein the DMA bitmap manipulation request is a request to count a number of ones in a source bitmap.

9. The at least one computer readable storage medium of claim 6, wherein the DMA bitmap manipulation request is a request to determine a first a first bit that is set to one in a source bitmap.

10. The at least one computer readable storage medium of claim 6, wherein the DMA bitmap manipulation request is a request to store indices of bits equal to one in a source bitmap to a contiguous memory location.

11. The at least one computer readable storage medium of claim 6, wherein the DMA bitmap manipulation request is a bitmap gather request.

12. The at least one computer readable storage medium of claim 6, wherein the DMA bitmap manipulation request is a bitmap scatter request.

13. A semiconductor apparatus comprising:
one or more substrates; and
logic coupled to the one or more substrates, wherein the logic is implemented at least partly in one or more of configurable or fixed-functionality hardware, the logic to:
detect, by an operation engine, a plurality of sub-instruction requests from a first memory engine in a plurality of memory engines, wherein the plurality of sub-instruction requests are associated with a direct memory access (DMA) bitmap manipulation request from a first pipeline, wherein each sub-instruction request corresponds to a data element in the DMA bitmap manipulation request, and wherein the first memory engine is to correspond to the first pipeline;
detect, by the operation engine, one or more arguments in the plurality of sub-instruction requests;
send, by the operation engine, one or more load requests to a dynamic random access memory (DRAM) in a plurality of DRAMs in accordance with the one or more arguments; and
send, by the operation engine, one or more store requests to the DRAM in accordance with the one or more arguments, wherein the operation engine is to correspond to the DRAM.

14. The semiconductor apparatus of claim 13, wherein the one or more arguments include one or more of a DMA type argument, an index array argument, a result address argument or a destination bitmap address argument.

15. The semiconductor apparatus of claim 13, wherein the DMA bitmap manipulation request is a request to count a number of ones in a source bitmap.

16. The semiconductor apparatus of claim 13, wherein the DMA bitmap manipulation request is a request to determine a first a first bit that is set to one in a source bitmap.

17. The semiconductor apparatus of claim 13, wherein the DMA bitmap manipulation request is a request to store indices of bits equal to one in a source bitmap to a contiguous memory location.

18. The semiconductor apparatus of claim 13, wherein the DMA bitmap manipulation request is a bitmap gather request.

19. The semiconductor apparatus of claim 13, wherein the DMA bitmap manipulation request is a bitmap scatter request.

20. The semiconductor apparatus of claim 13, wherein the logic coupled to the one or more substrates includes transistor channel regions that are positioned within the one or more substrates.
